(19) United States
(12) Patent Application Publication
(10) Pub. No.: US 2022/0356934 A1
(43) Pub. Date: Nov. 10, 2022

(54) TOLERANCE RING WITH STOP

(71) Applicant: SFS Group International AG, Heerbrugg/St. Gallen (CH)

(72) Inventors: Stefan FREI, Chur (CH); Markus SCHÖNENBERGER, Kirchberg (CH); Alexander Christoph STAUDIGL, Bezau (AT)

(73) Assignee: SFS Group International AG, Heerbrugg/St. Gallen (CH)

(21) Appl. No.: 17/738,455

(22) Filed: May 6, 2022

(30) Foreign Application Priority Data
May 7, 2021 (EP) 21172872.0

(51) Int. Cl. F16H 25/24; F16H 25/22

(52) U.S. Cl. CPC F16H 25/24; F16H 25/2204

(57) ABSTRACT

A tolerance ring is an intermediate element for a shaft/hub connection that is positioned in a groove between shaft and hub and that produces a force-fitting connection between these two elements. It has substantially the shape of a hollow cylinder, wherein the lateral surface thereof has embossments in the form of radially inwardly and/or outwardly pointing elevations. Here, provision is made at one longitudinal end of a flange-like collar, which is applied in a radial plane with respect to the central longitudinal axis. The tolerance ring is preferably manufactured in one piece with the flange-like collar from metal as a deep-drawn part, preferably being manufactured from aluminum or an aluminum alloy. An assembly method for such a tolerance ring, and a ball screw drive, and a screw drive, having such a tolerance ring are also provided.

### TECHNICAL FIELD

The present invention is concerned with a so-called tolerance ring, specifically for use at a ball screw drive.

### BACKGROUND

A tolerance ring is essentially an intermediate element for a shaft/hub connection. It generally consists of spring steel and is positioned in a groove between shaft and hub, where it produces a force-fitting connection between these two elements. By virtue of its flexibility, a tolerance ring makes possible both compensation of manufacturing tolerances and compensation of thermal expansion. A tolerance ring normally consists of metal and has a cylindrical basic shape. The lateral surface of the cylinder generally has embossments, these being surface structures which are formed by deformation of the metal and which form regular elevations, normally in the form of a wavy line. A tolerance ring consequently has a free inner diameter and a free outer diameter, the difference of which is larger than the wall thickness of the ring material.

For the purpose of assembly, the tolerance ring is pushed or pressed onto the shaft or into the hub and is subsequently press-fitted to the counterpart. The embossments are plastically deformed in the process and produce a force-fitting connection of shaft and hub. A tolerance ring may also be provided with an axial separating slot, which can facilitate the assembly. These variants, moreover, can be easily produced from band material by embossment and, according to the desired circumference of the tolerance ring, can be fabricated by simple cutting-to-length and bending of endlessly produced starting material.

A roller screw drive with balls as rolling bodies is commonly referred to as recirculating-ball spindle or else as ball screw drive. A ball screw drive is a special form of a screw drive. The main constituent parts of a ball screw drive include a threaded spindle and a spindle nut which engages around said spindle. The threads are configured as mutually complementary ball grooves, which permits circulation of balls between threaded spindle and spindle nut during operation because the inner and outer threads act jointly as a ball guide. Unlike in the case of a connection that is purely a screw/nut connection, in which the thread flanks slide one on the another in an areal manner, in the case of the ball screw drive, the circulating balls in the ball channel perform the load transmission between nut and spindle. The planar sliding movement is thus replaced by a rolling movement, this being associated with reduced friction.

In order to obtain a closed circulation path for the balls, one or more ball diversions are (normally) used in the spindle nut. Said ball diversions have the task of lifting the balls out from the ball guide between spindle nut and threaded spindle at a first location and feeding them back at a second location. The ball return guide thus constitutes a bypass, which bridges one or more thread flights of the nut/spindle system and thus permits closed encircling for the balls of a ball screw drive.

Screw drives, both designed as ball screw drives and as nut/spindle screw drives, are used in a large number of technical applications as a linear drive, particularly in mechanical engineering and, in this case, preferably in the area of power tools. Ball screw drives and nut/spindle screw drives nowadays also play an increasing role in electromechanical and electrohydraulic braking systems, where they are used as a replacement for hydraulic brake cylinders or in parallel with known braking systems in the case of braking assistance systems.

### PRIOR ART

In the aforementioned application in a braking system or braking assistance system, the threaded spindle of a ball screw drive is normally connected at a longitudinal end to a drive unit, while the spindle nut acts on a brake piston or on another actuation or transmission element. It is commonly the case that ball screw drives moreover have components which are pushed axially onto the threaded spindle, such as support disks or radial stop elements. These are positioned for example on a portion of the threaded spindle that is in the form of an external hexagon and are held there by a securing ring (split-pin ring, pressing ring).

### SUMMARY

The present invention is based on the object of presenting a tolerance ring which, beside its core function as force-fitting connecting element between a hub and an end portion, in the form of a shaft, of a threaded spindle, can moreover also provide the function of a securing ring.

A tolerance ring according to the invention has substantially a hollow-cylindrical basic shape (also, in short: hollow cylinder) with a first longitudinal end and a second longitudinal end. Also, a central longitudinal axis marks the axis of symmetry/central axis. The lateral surface of the hollow cylinder has embossments in the form of radially inwardly and/or outwardly pointing elevations. Said embossments are applied so as to provide for the force fit/form fit, in a manner plastically deformed between shaft and hub, during the assembly. Provision is made at the second axial end of a flange-like collar, which is applied in a radial plane with respect to the central longitudinal axis. Here, flange-like means the form of the collar which is applied arealy, preferably in a circular-ring-shaped manner, in the radial plane.

The tolerance ring with stop can be manufactured in one piece from metal as a deep-drawn part. The preferred material is aluminum or an aluminum alloy. In a practical embodiment, such a tolerance ring can be deformed out of a smooth tube portion or be deep drawn from a flat, for example roundly punched out, aluminum part. The resulting material thickness may be configured according to purpose of use and has natural limits in terms of the deformability of the material. For example, effective wall thicknesses in the region of 0.3 mm have been realized, wherein different wall thicknesses can be realized in different regions of the tolerance ring according to deformation process. Thus, through suitable process control, the flange may also be configured to be thicker than the lateral-surface region of the hollow cylinder with its embossments. Said embossments may be realized as surface structures which are embossed in a corrugated, fluted or ribbed manner in the lateral surface.

The transition region from the hollow-cylindrical basis shape to the flange-like collar is preferably formed to be smooth, that is to say substantially without edges and kinks. The embossments in the lateral surface may terminate in the transition region or transition into the latter. The flange-like collar, owing to its function as stop, is preferably in the form of a smooth circular ring. Surface structurings or linings, for improving or increasing the securing function, are not excluded.

A method for securing in a defined end position a flat ring element is described below. Said ring element is attached to the threaded spindle of a ball screw drive. Here, in the simplest case, a ring element may be a component in the form of a shim having a central opening. This central opening may also be in the form of a polygon, in order for example to match a complementary structure on the threaded spindle in a form-fitting manner. The ring element may, as in the prior art, be a spindle support disk, a bearing element or a radial stop. Here, the method comprises the steps described below. Said steps specify a logical sequence, which however may be interrupted, and complemented, by intermediate steps without disrupting the core of the method.
providing a threaded spindle having a substantially cylindrical thread-free end portion. Here, as described in the present usage situation, thread is to be understood as meaning in particular a thread in the form of a ball groove.
providing a target position on said end portion of the threaded spindle, which target position has a longitudinal stop which is able to limit the movement of the provided ring element in a first axial direction. Said longitudinal stop may for example be a step or a ring (also sectionally interrupted).
pushing the ring element onto the end portion until the longitudinal stop is reached.
bringing a tolerance ring having the above-described properties onto the end portion of the threaded spindle, specifically with the flange-like collar at the front, until the collar (flange), in a defined manner, presses the ring element against the longitudinal stop and fixes said ring element in the target position.

Furthermore, for securing the ring element, the region of the flange-like collar may be pressed in a punctiform or areal manner against the end portion of the threaded ring. Furthermore, an encircling incision may be provided in the threaded spindle in the end portion of the threaded spindle in the region of the target position. By way of compression, the transition region of the tolerance ring engages into the incision and maintains the position.

It is then possible for the threaded spindle provided with the tolerance ring, performing the function as an intermediate element of a shaft/hub connection, to be connected to a hub or to a drive element or driven element.

As mentioned multiple times, the primary, but not sole, application area of the tolerance ring involves a ball screw drive. Said ball screw drive comprises substantially a threaded spindle which has an outer thread and a spindle nut which engages around said spindle and which has an inner thread. The thread flights are configured as mutually complementary ball grooves and, in the fitted state between threaded spindle and spindle nut, receive a multiplicity of balls. Said balls are kept in endless ball circulation by a ball return guide which bridges one or more thread turns. At one longitudinal end, the threaded spindle has a substantially cylindrical thread-free end portion with a target position, said target position being provided with a longitudinal stop. This serves for limiting the movement of a ring element provided there in a first axial direction. According to the invention, a tolerance ring according to the above description is provided for the purpose of being pushed onto the end portion of the threaded spindle and of defining the end position of a ring element.

A screw drive without balls can be equipped with a tolerance ring in a manner similar to a ball screw drive. Such a screw drive, such as for example a trapezoidal screw drive, likewise has a thread formed from a threaded spindle and spindle nut, but the thread turns in the case of said thread directly slide one on the other or mesh into one another. The sliding friction, in comparison with the ball rolling friction of a ball screw drive, gives rise to lower efficiency, but greater axial forces can be transmitted with reduced effort.

### BRIEF DESCRIPTION OF THE DRAWINGS

FIG. 1 shows a tolerance ring according to the present description in a side view.

FIG. 2 shows the tolerance ring in FIG. 1 in an axial plan view, in the cross section of the plane B-B.

FIG. 3 shows a ring element on the end portion of a threaded spindle, secured by a tolerance ring with stop flange according to the present invention, in longitudinal section.

FIG. 4 shows a ring element secured according to the prior art in longitudinal section.

### DETAILED DESCRIPTION

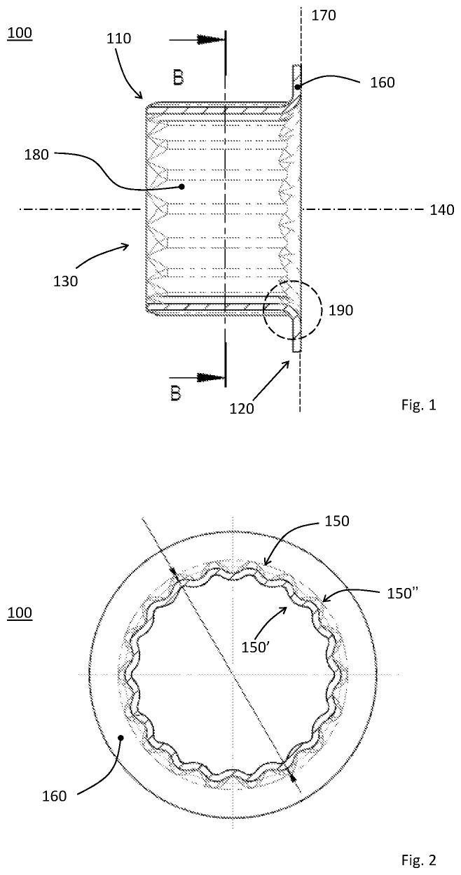

FIGS. 1 and 2 show a side view and cross-sectional view, respectively, of the same component and are therefore described together. A tolerance ring 100 with stop, as shown here, has two basic functional regions. The main body or the basic shape 130 is a hollow cylinder with a central longitudinal axis 140 and with a first longitudinal end 110 which terminates in a cylindrical manner. The second longitudinal end 120 bears the flange-like collar 160, which lies in a radial plane 170 which is oriented perpendicularly to the central longitudinal axis. A smooth transition region 190 marks the transition from the hollow cylinder 130 into the collar 160. The lateral surface 180 of the hollow-cylinder basic shape 130 is in some regions ribbed, corrugated, or deformed out of the purely cylindrical shape, in order to form the embossments 150, 150′, 150″. As FIG. 2 shows in cross section, in this way, a clear inner radius and a clear outer radius are defined by the peaks and troughs, respectively, of the embossments.

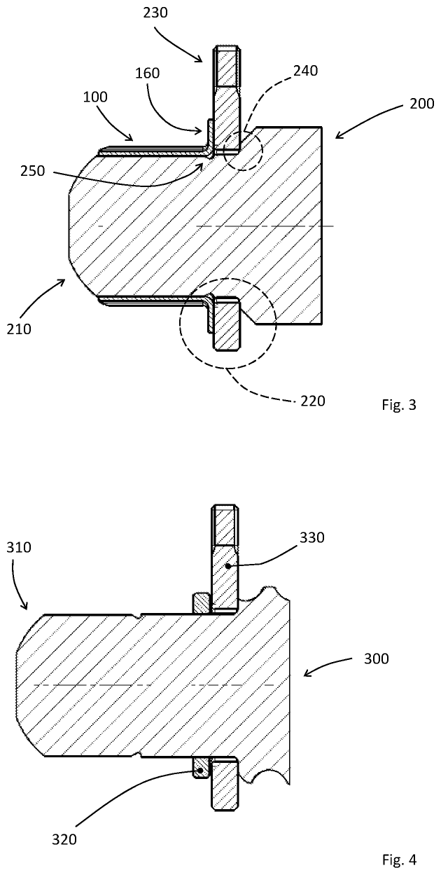

FIGS. 3 and 4 show the end portion 210, 310 of a threaded spindle 200 and 300, respectively. Such a threaded spindle may be both part of a ball screw drive or part of a nut/spindle screw drive. A ring element which, for example, forms a radial stop or the support disk of a bearing is denoted by 230 and 330, respectively. Said ring element is pushed onto the end portion 210, 310 and secured. In the case of FIG. 4, according to the prior art, this is realized by a securing ring 320.

FIG. 3 shows the solution according to the invention. The ring element 230 abuts against the axial longitudinal stop 240 in the end portion 210 in a defined manner. A tolerance ring 100 is in a state pushed onto the end of the threaded spindle 200 such that the flange-like collar 160, together with the longitudinal stop 240, fixes the ring element 230 in the target position 220 in a defined manner. An encircling incision 250 in the threaded spindle 250 makes it possible to provide a defined seat through compression or pressing-on at least of the transition region 190 of the tolerance ring.

1. A tolerance ring, comprising:
a substantially hollow-cylindrical basic shape with a first axial longitudinal end and a second axial longitudinal end and with a central longitudinal axis;
a lateral surface of the hollow cylinder has embossments in the form of comprising embossments formed of at least one of radially inwardly or outwardly pointing elevations; and
a flange-shaped collar applied at the second axial longitudinal end in a radial plane with respect to the central longitudinal axis.

2. The tolerance ring as claimed in claim 1, wherein the tolerance ring with the flange-shaped collar is formed in one piece from metal as a deep-drawn part.

3. The tolerance ring as claimed in claim 1, wherein the tolerance ring is comprised manufactured from aluminum or an aluminum alloy.

4. The tolerance ring as claimed in claim 1, wherein a transition region from the hollow-cylindrical basis shape to the flange-shaped collar is smooth.

5. The tolerance ring as claimed in claim 1, wherein the embossments in the lateral surface are realized as surface structures which are corrugated, fluted or embossed in a ribbed manner.

6. A method for securing in a defined end position a flat ring element that is to be attached to the threaded spindle of a ball screw drive, the method comprising the steps of:
providing a threaded spindle having a substantially cylindrical thread-free end portion;
providing a target position on said end portion of the threaded spindle, said target position has a longitudinal stop which is configured to limit a movement of the flat ring element in a first axial direction;
pushing the flat ring element onto the end portion until the longitudinal stop is reached; and
bringing a tolerance ring as claimed in claim 1 onto the end portion of the threaded spindle, with the flange-shaped collar at a front, until the collar, in a defined manner, presses the ring element against the longitudinal stop and fixes said ring element in the target position.

7. The method as claimed in claim 6, further comprising, for securing the ring element, pressing a region of the flange-shaped collar in a punctiform or areal manner against the end portion of the threaded ring.

8. The method as claimed in claim 7, further comprising providing an encircling incision in the end portion of the threaded spindle in a region of the target position, into which encircling incision the transition region of the tolerance ring engages after being pressed on.

9. The method as claimed in claim 6, wherein the threaded spindle provided with the tolerance ring is connected to a hub.

10. A ball screw drive, comprising:
a threaded spindle which has an outer thread and a spindle nut which engages around said spindle and which has an inner thread;
thread flights are configured as mutually complementary ball grooves which, in a fitted state between threaded spindle and spindle nut, receive a multiplicity of balls, said balls being kept in endless ball circulation by a ball return guide which bridges one or more thread turns;
at one longitudinal end, the threaded spindle has a substantially cylindrical thread-free end portion with a target position, said target position being provided with a longitudinal stop which is configured to limit a movement of a ring element provided there in a first axial direction; and
a tolerance ring as claimed in claim 1 that is pushed onto the end portion of the threaded spindle and defines an end position of a ring element.

11. A screw drive, comprising:
a threaded spindle which has an outer thread and a spindle nut which engages around said spindle and which engages with the outer thread of said spindle via a complementary inner thread;
at one longitudinal end, the threaded spindle has a substantially cylindrical thread-free end portion with a target position, said target position being provided with a longitudinal stop which is configured to limit a movement of a ring element provided there in a first axial direction; and
a tolerance ring as claimed in claim 1 is pushed onto an end portion of the threaded spindle and defines an end position of a ring element.
